(19) United States
(12) Patent Application Publication
(10) Pub. No.: US 2023/0281759 A1
(43) Pub. Date: Sep. 7, 2023

(54) DEPTH MAP ACCURACY IMPROVEMENT APPARATUS, METHOD, AND PROGRAM

(71) Applicant: Nippon Telegraph and Telephone Corporation, Tokyo (JP)

(72) Inventors: Shinji Fukatsu, Musashino-shi, Tokyo (JP); Takashi SANO, Musashino-shi, Tokyo (JP); Yumi KIKUCHI, Musashino-shi, Tokyo (JP); Masato Ono, Musashino-shi, Tokyo (JP)

(21) Appl. No.: 18/016,592

(22) PCT Filed: Jul. 22, 2020
(86) PCT No.: PCT/JP2020/028444

§ 371 Date: Jan. 17, 2023

(51) Int. Cl. G06T 5/00; G06T 7/11; G06T 7/194; G06T 3/40; G06T 7/50

(52) U.S. Cl. CPC G06T 5/002; G06T 7/11; G06T 7/194; G06T 3/40; G06T 7/50; G06T 2207/20021; G06T 2207/10024; G06T 2207/20192; G06T 2200/04

(57) ABSTRACT

An accuracy improvement device 1 of the present embodiment includes: a painting processing unit 13 that generates a segmentation image obtained by painting each of a plurality of regions in an RGB image to be processed, with a designated color, on the basis of a segmentation result obtained by dividing the RGB image to be processed into the plurality of regions, and a smoothing processing unit 15 that uses the segmentation image as a guide image to execute edge retention smoothing processing on a depth map estimated from the RGB image to be processed.

### TECHNICAL FIELD

The present invention relates to a depth map accuracy improvement device, method, and program.

### BACKGROUND ART

Generally, in depth estimation, depth values of respective pixels of an RGB image are estimated. When a depth map obtained by depth estimation is compared with an RGB image, noise is large because estimation accuracy is low, and particularly, the depth of a boundary portion of each object becomes ambiguous, and post-processing for improving the accuracy of the depth map such as removal of an outlier and fluctuation is required.

When the depth map is used for 3D conversion, the more precise the relation between the objects in the RGB image and the depths of the objects in the depth map, the clearer a 3D image can be generated.

Edge retention smoothing using an RGB image is known as a method for clarifying a pixel value boundary in a depth map by transferring edge information (pixel value boundary) of an RGB image to the depth.

### CITATION LIST

### Non Patent Literature

[NPL 1] Johannes Kopf, Michael F. Cohen, Dani Lischinski, and Matt UyttenDaele, “Joint Bilateral Upsampling”

[NPL 2] Takuya Matsuo, Norishige Fukushima, and Yutaka Ishibashi,“Weighted Joint Bilateral Filter with Slope Depth Compensation Filter for Depth Map Refinement”

### SUMMARY OF INVENTION

### Technical Problem

However, in the prior art, there is no distinction between the edge around an object and the edge inside the object, and if a filter is applied strongly to clarify the boundary of the object, there arises a problem that the edge part inside the object is also strongly filtered. As a result, the depth information inside the object becomes a value that greatly deviates from the estimation result, which reduces the accuracy of the depth map.

The present invention was contrived in view of the above and an object thereof is to improve the accuracy of a depth map.

### Solution to Problem

An accuracy improvement device of one aspect of the present invention is an accuracy improvement device for improving accuracy of a depth map, and includes a painting processing unit that generates a segmentation image obtained by painting each of a plurality of regions in an image to be processed, with a designated color, on the basis of a segmentation result obtained by dividing the image to be processed into the plurality of regions, and a smoothing processing unit that uses the segmentation image as a guide image to execute edge retention smoothing processing on a depth map estimated from the image to be processed.

An accuracy improvement method according to one aspect of the present invention is an accuracy improvement method executed by a computer, the accuracy improvement method including generating a segmentation image obtained by painting each of a plurality of regions in an image to be processed, with a designated color, on the basis of a segmentation result obtained by dividing the image to be processed into the plurality of regions, and using the segmentation image as a guide image to execute edge retention smoothing processing on a depth map estimated from the image to be processed.

### Advantageous Effects of Invention

According to the present invention, the accuracy of a depth map can be improved.

### BRIEF DESCRIPTION OF DRAWINGS

FIG. 1 is a block diagram illustrating an example of a configuration of an accuracy improvement device of a present embodiment.

FIG. 2 is a diagram illustrating an example of an RGB image.

FIG. 3 is a diagram illustrating an example of a depth map estimated from the RGB image of FIG. 2.

FIG. 4 is a diagram illustrating an example of segmentation results divided by regions of objects detected from the RGB image of FIG. 2.

FIG. 5 is a diagram illustrating an example of a depth map output by the accuracy improvement device of the present embodiment.

FIG. 6 is a flowchart illustrating a processing flow of the accuracy improvement device of the present embodiment.

FIG. 7 is a diagram illustrating an example of a depth map obtained by further performing edge retention smoothing using the RGB image as a guide.

FIG. 8 is a diagram illustrating an example of a hardware configuration of the accuracy improvement device.

### DESCRIPTION OF EMBODIMENTS

Embodiments of the present invention will be described hereinafter with reference to the drawings.

### Configuration

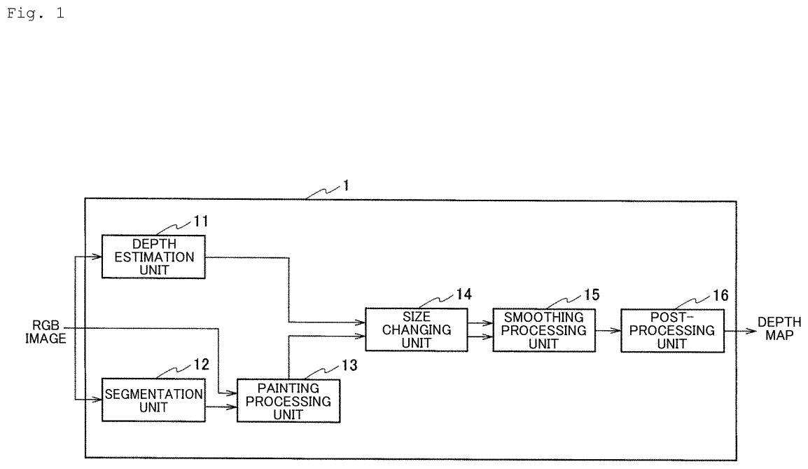

FIG. 1 is a block diagram illustrating an example of a configuration of an accuracy improvement device 1 of the present embodiment. The accuracy improvement device 1 illustrated in FIG. 1 includes a depth estimation unit 11, a segmentation unit 12, a painting processing unit 13, a size changing unit 14, a smoothing processing unit 15, and a post-processing unit 16. The accuracy improvement device 1 inputs an RGB image to be processed, estimates a depth map from the RGB image, generates a segmentation image by dividing the RGB image into regions and painting these regions, and outputs a depth map obtained by edge retention smoothing using the painted segmentation image as a guide image.

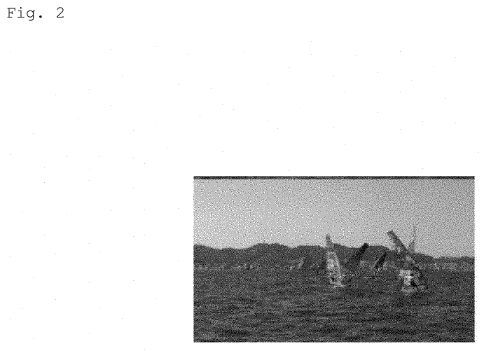

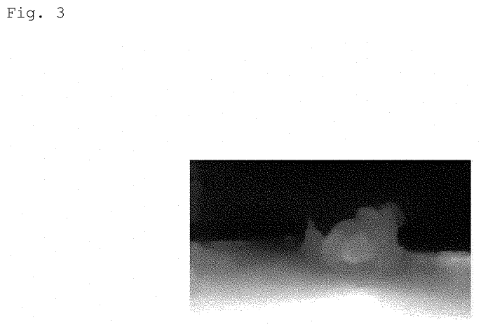

The depth estimation unit 11 inputs the RGB image, estimates a depth map, and outputs the depth map. The depth map is image data in which the depth of each pixel is expressed by 256 gradations of gray from 0 to 255. For example, the deepest part is 0 and the front side is 255. The depth map may have a gradation other than the 256 gradations. FIG. 2 illustrates an example of an RGB image to be input, and FIG. 3 illustrates an example of a depth map estimated from the RGB image of FIG. 2. For example, a method called Depth from Videos in the Wild can be used for estimating a depth map. Without the depth estimation unit 11, the accuracy improvement device 1 may input a depth map that is estimated from the RGB image by an external device.

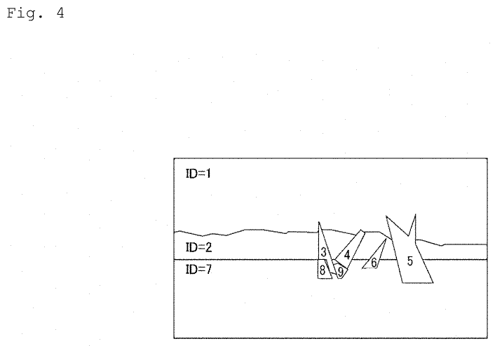

The segmentation unit 12 inputs the RGB image, detects objects in the image, and outputs a segmentation result obtained by dividing regions where the objects exist into pixel units. The segmentation result is data in which segment IDs are assigned to the respective regions divided for the respective detected objects. For example, the segmentation result is data with segment IDs assigned with respect to pixel units. FIG. 4 illustrates an example of a segmentation result. In the example illustrated in FIG. 4, the RGB image is divided into nine regions, and segment IDs of 1 to 9 are assigned to the respective regions. For the segmentation processing, for example, a method called Mask R-CNN can be used. Without the segmentation unit 12, the accuracy improvement device 1 may input the segmentation result obtained by segmentation processing performed on the RGB image by an external device.

The painting processing unit 13 inputs the segmentation result and the RGB image, fills each of the regions in the segmentation result with a color corresponding to the average of pixel values of the respective regions in the RGB image, and outputs the painted segmentation image. By using the average of the pixel values of the respective regions in the RGB image as the paint color, the difference in color between objects in the RGB image is reflected in edge determination. The edges of the contours between regions with a large hue difference are conspicuous, whereas the edges of the contours between regions with a small hue difference are not conspicuous. Thus, a depth map in which object boundaries are enhanced can be generated while reflecting the color information of the RGB image. The painting processing unit 13 blacks out an area that is not extracted as a region in the segmentation result. A color that is not used in other segments may be used instead of black.

The size changing unit 14 inputs the depth map and the painted segmentation image, changes the sizes of the depth map and the painted segmentation image, and outputs the depth map and the painted segmentation image of the same size. The size changing unit 14 may change the sizes of the depth map and the painted segmentation image to the same size as the original RGB image. Most of the depth estimation processing and the segmentation processing are performed using an image obtained by reducing the original image, in order to reduce the processing costs. If the depth map and the painted segmentation image are the same in size, the processing by the size changing unit 14 is not necessary. By estimating the reduced depth map and segmentation result, respective processing times for the depth map estimation processing and the segmentation processing are shortened, and as a result, the processing time required in the entire system can be shortened.

The smoothing processing unit 15 inputs the depth map and the painted segmentation image, performs edge retention smoothing on the depth map using the painted segmentation image as a guide, and outputs the depth map obtained after the edge retention smoothing. Here, using the painted segmentation image as a guide means that the smoothing processing is performed on the depth map based not on the information on the depth map (color difference or distance proximity) but on the information on the painted segmentation image. More specifically, the smoothing processing unit 15 uses the painted segmentation image as a guide image and uses a Joint Bilateral Filter or a Guided Filter to perform the edge retention smoothing processing on the depth map. Although the accuracy is improved by repeated execution of the filter processing, repeating the filter processing excessively results in excessive smoothing. Therefore, the appropriate number of times is determined based on the conspicuousness of the edges of contour portions and the degree of smoothing inside the objects.

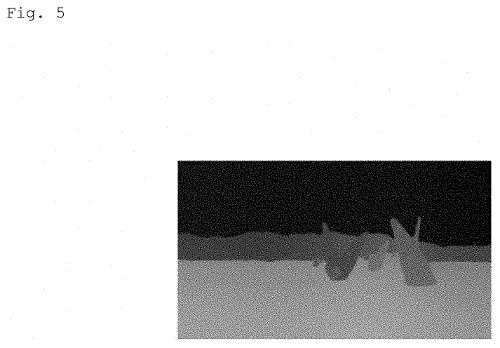

The post-processing unit 16 inputs the depth map obtained after the edge retention smoothing processing, applies a blur removal filter to the depth map, and outputs the depth map in which the boundary portions of the objects are made clear. When smoothing is performed by the smoothing processing unit 15, blur and haze occur around the objects in the depth map. Therefore, in the present embodiment, the post-processing unit 16 is provided to generate a depth map having clear boundary portions. A Detail Enhance Filter can be used as the blur removal filter for removing blur and haze. It should be noted that the processing performed by the post-processing unit 16 is not necessary. Without the processing performed by the post-processing unit 16, a depth map with sufficiently high accuracy can be generated by the steps up to the one performed by the smoothing processing unit 15. FIG. 5 illustrates an example of an output of a depth map output.

### Operations

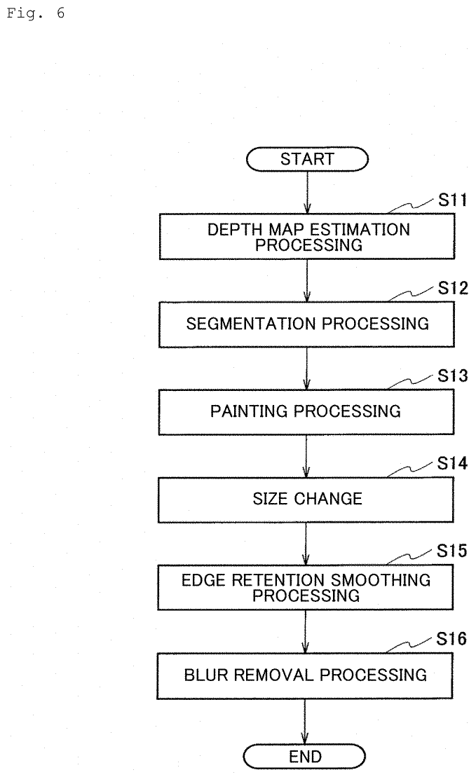

A processing flow of the accuracy improvement device 1 of the present embodiment will be described with reference to the flowchart of FIG. 6.

In step S11, the depth estimation unit 11 estimates a depth map from an RGB image. The accuracy improvement device 1 may input a depth map estimated by an external device.

In step S12, the segmentation unit 12 detects objects in the RGB image and divides the RGB image into regions of the respective detected objects. The accuracy improvement device 1 may input a segmentation result obtained by an external device.

In step S13, the painting processing unit 13 fills the respective regions divided by the segmentation result with a color corresponding to the average of pixel values of the respective regions in the RGB image.

In step S14, the size changing unit 14 changes the sizes of the depth map and the painted segmentation image.

In step S15, the smoothing processing unit 15 performs edge retention smoothing processing on the depth map by using the painted segmentation image as a guide.

In step S16, the post-processing unit 16 applies a blur removal filter to the depth map.

### Modifications

Next, modifications of the painting processing and the depth map smoothing processing will be described.

In the processing by the painting processing unit 13 in which each of a plurality of regions in the RGB image is painted with a designated color on the basis of a segmentation result obtained by dividing the RGB image into the plurality of regions, the respective regions may be painted with random colors, or the segmentation result may be collated with the depth map to paint the respective regions with colors in grayscale corresponding to the average of the values indicating the depths of the respective regions in the depth map. In so doing, a region that is not extracted as a segmentation result is painted in black.

Alternatively, the painting processing unit 13 may select colors to paint the respective regions in such a manner as to make the difference in color between adjacent regions significant. For example, the adjacent regions are filled with colors that are opposite in the hue circle (complementary colors). Segment IDs are sequentially assigned laterally, starting with, for example, the upper left region, and once the segment IDs are assigned all the way to the right end, segment IDs are assigned to the next line, starting with the left end. Then, the colors that are opposite in the hue circle are sequentially selected in the order of the segment IDs to fill the regions.

Alternatively, the painting processing unit 13 may select a color to paint each region on the basis of the categories of the objects detected in the segmentation processing. For example, the painting processing unit 13 paints background regions such as sky, sea, and walls with cool colors and paints regions of objects (subjects) such as a person and ship with warm colors. In this manner, the edges of the boundary portions between a subject and the background can be made conspicuous, thereby separating the subject and the background, and generation of a depth map in which the subject is conspicuous can be expected.

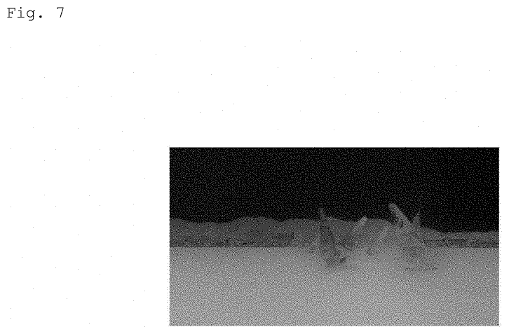

The smoothing processing unit 15 may perform the edge retention smoothing on the depth map by using the RGB image as a guide, in addition to performing the edge retention smoothing on the depth map by using the segmentation image as a guide. The edge retention smoothing using an RGB image as a guide can be performed in the same manner as in the prior art. As a result, a depth map in which the boundary portions of the objects are vivid can be generated, but since the depth information in the objects also change as shown in FIG. 7, the edge retention smoothing needs to be employed in consideration of such changes.

As described above, the accuracy improvement device 1 of the present embodiment includes the painting processing unit 13 that generates a segmentation image obtained by painting each of a plurality of regions in an RGB image to be processed, with a designated color, on the basis of a segmentation result obtained by dividing the RGB image to be processed into the plurality of regions, and the smoothing processing unit 15 that uses the segmentation image as a guide image to execute edge retention smoothing processing on a depth map estimated from the RGB image to be processed. This can prevent unintended erroneous processing of depths inside the objects while clarifying the boundaries of the objects in the depth map. As a result, the accuracy of the depth map can be improved, and a clear 3D image can be generated.

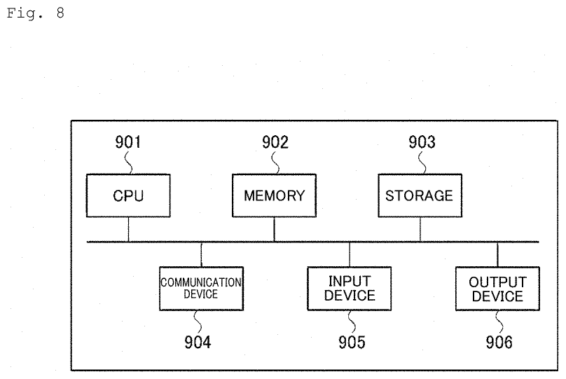

As the accuracy improvement device 1 described above, a general-purpose computer system including, for example, a central processing unit (CPU) 901, a memory 902, a storage 903, a communication device 904, an input device 905, and an output device 906, as illustrated in FIG. 8, can be used. In this computer system, the accuracy improvement device 1 is implemented by the CPU 901 executing a predetermined program loaded into the memory 902. This program can be recorded on a computer-readable recording medium such as a magnetic disk, an optical disk, or a semiconductor memory, or distributed over a network.

### REFERENCE SIGNS LIST

1 Accuracy improvement device
11 Depth estimation unit
12 Segmentation unit
13 Painting processing unit
14 Size changing unit
15 Smoothing processing unit
16 Post-processing unit

1. An accuracy improvement device for improving accuracy of a depth map, comprising:
a painting processing unit, including one or more processors, configured to generate a segmentation image obtained by painting each of a plurality of regions in an image to be processed, with a designated color, on a basis of a segmentation result obtained by dividing the image to be processed into the plurality of regions; and
a smoothing processing unit, including one or more processors, configured to use the segmentation image as a guide image to execute edge retention smoothing processing on a depth map estimated from the image to be processed.

2. The accuracy improvement device according to claim 1, wherein the painting processing unit is configured to paint each of the plurality of regions with an average of pixel values of the respective regions in the image to be processed.

3. The accuracy improvement device according to claim 1, wherein the painting processing unit is configured to paint each of the plurality of regions with a complementary color such that a difference in color between adjacent regions becomes significant.

4. The accuracy improvement device according to claim 1, wherein
the smoothing processing unit is further configured to perform edge retention smoothing processing on the depth map by using the image to be processed as a guide image.

5. The accuracy improvement device according to claim 1, further comprising
a size changing unit including one or more processors, configured to make the size of the depth map and the size of the segmentation image identical.

6. An accuracy improvement method executed by a computer, comprising:
generating a segmentation image obtained by painting each of a plurality of regions in an image to be processed, with a designated color, on a basis of a segmentation result obtained by dividing the image to be processed into the plurality of regions; and
using the segmentation image as a guide image to execute edge retention smoothing processing on a depth map estimated from the image to be processed.

7. A non-transitory computer readable medium storing one or more instructions causing a computer to execute:
generating a segmentation image obtained by painting each of a plurality of regions in an image to be processed, with a designated color, on a basis of a segmentation result obtained by dividing the image to be processed into the plurality of regions; and
using the segmentation image as a guide image to execute edge retention smoothing processing on a depth map estimated from the image to be processed.

8. The accuracy improvement method according to claim 6, comprising:
painting each of the plurality of regions with an average of pixel values of the respective regions in the image to be processed.

9. The accuracy improvement method according to claim 6, comprising:
painting each of the plurality of regions with a complementary color such that a difference in color between adjacent regions becomes significant.

10. The accuracy improvement method according to claim 6, comprising:
performing edge retention smoothing processing on the depth map by using the image to be processed as a guide image.

11. The accuracy improvement method according to claim 6, comprising:
making the size of the depth map and the size of the segmentation image identical.

12. The non-transitory computer readable medium according to claim 7, wherein the one or more instructions cause the computer to execute:
painting each of the plurality of regions with an average of pixel values of the respective regions in the image to be processed.

13. The non-transitory computer readable medium according to claim 7, wherein the one or more instructions cause the computer to execute:
painting each of the plurality of regions with a complementary color such that a difference in color between adjacent regions becomes significant.

14. The non-transitory computer readable medium according to claim 7, wherein the one or more instructions cause the computer to execute:
performing edge retention smoothing processing on the depth map by using the image to be processed as a guide image.

15. The non-transitory computer readable medium according to claim 7, wherein the one or more instructions cause the computer to execute:
making the size of the depth map and the size of the segmentation image identical.
